(19) United States
(12) Patent Application Publication
(10) Pub. No.: US 2005/0078899 A1
(43) Pub. Date: Apr. 14, 2005

(54) Slewing ring

(76) Inventors: Didier Chatry, La Bruffiere (FR); Daniel Terve, St. Sebastien S/ Loire (FR)

Correspondence Address: BACHMAN & LAPOINTE, P.C., 900 CHAPEL STREET, SUITE 1201, NEW HAVEN, CT, 06510, US

(21) Appl. No.: 10/926,466

(22) Filed: Aug. 26, 2004

(30) Foreign Application Priority Data
Aug. 27, 2003 (FR) 03 10220

(51) Int. Cl. F16C 33/58; F16C 33/76

(52) U.S. Cl. 384/513

(57) ABSTRACT

A slewing ring comprises a retainer in metal of a certain hardness substantially equal to the hardness of two rings. The retainer is arranged between the two rings. The retainer is integral in rotation with rolling elements, and holds these elements regularly spaced apart in a raceway. At least one contact ring, made of a material of different hardness than the hardness of the rings and the retainer, is arranged between two members formed by the retainer and by one of the two rings. Each contact ring prevents any direct contact between the two members, is fixed to one of the two members, and is able to come into contact with the other.

### BACKGROUND OF THE INVENTION

1. Field of the Invention

The present invention pertains to a slewing ring, in particular a ball bearing.

2. Description of Related Art

A slewing ring is known of the type comprising rolling elements, two concentric metal rings having a predetermined hardness, one inner and one outer, mobile in rotation relative to one another and defining a raceway for said rolling elements, and a retainer made of a metal having a hardness substantially equal to the hardness of the rings, the retainer being arranged between the two rings, and being integral in rotation with the rolling elements, said retainer holding the rolling elements regularly spaced apart in the raceway.

A major disadvantage of this type of ring is that during the rotation movement, the retainer comes into contact with the rings and undergoes wear due to resulting friction. This wear leads firstly to pollution of the lubricant whose properties are thereby weakened, and secondly to reduced lifetime of the rings.

On this account solutions have been put forward : heat and/or chemical treatment of the surface of the rings at the point of contact with the retainer (for example US 2001/48781 or EP 0 531 082), because this treatment should not be applied to the raceway, it is difficult to implement especially with large diameter rings; or providing the retainer with porous elements containing a lubricant (for example GB 1 396 220 and JP 10 089 365), which enormously complicates the fabrication of the retainer.

The problem raised is to obtain a slewing ring in which the pollution of the lubricant is highly reduced and whose lifetime is considerably increased.

### DESCRIPTION OF THE INVENTION

The solution to this problem is a slewing ring of the aforesaid type comprising at least one circular contact ring made of a material having an hardness different from the hardness of the rings and the hardness of the retainer, said contact ring being housed in a groove made in one of the two rings, and the retainer coming in contact against said circular contact element, preventing any direct contact between the retainer and the ring in which the groove is made.

Therefore, the use of a contact ring according to the invention makes possible to easily produce slewing rings, with economical advantages. The wearing of their component elements of the slewing ring of the invention is considerably reduced (even eliminated). On this account, there are no more metal particles to pollute the lubricant (which therefore remains its properties longer). Consequently the time delay between two periodic lubrications of the slewing ring can be increased and the risk of retainer rupture is reduced (even eliminated). In addition, the noise generated by the slewing ring is strongly reduced. This is the case even with large diameter rings (at least 1 m diameter).

Other particularities and advantages will be understood from the following detailed description of a particular embodiment given as a non-restrictive example and illustrated by the appended drawing.

### BRIEF DESCRIPTION OF THE DRAWINGS

The single FIGURE shows a partial axial-section view of a slewing ring according to the present invention.

### DETAILED DESCRIPTION OF THE PREFERRED EMBODIMENT

As can be seen in the FIGURE, in known manner, a slewing ring 1 comprises:
rolling elements 2 (in this example ball elements 2),
two concentric rings 3, 4 (one inner 3 and one outer 4), in steel, mobile in rotation relative to one another and forming a raceway 5 for ball elements 2, and
a retainer 6 in steel arranged between the two rings 3, 4, extending in the axial direction of slewing ring 1 on either side of the ball elements 2, the retainer being integral in rotation with the ball elements and holding them regularly spaced apart in the raceway 5.

Also, the slewing ring 1 comprises contact elements also called contact rings 7a, 7b, 7c, 7d made of a non-ferrous material, polyamide in this case, for example polyamide-6,6.

Each contact ring 7a, 7b, 7c, 7d is arranged between two members formed by retainer 6 and by one of the two rings 3, 4. The contact ring prevents any direct contact between these two members 3, 4; 6, and is fixed to one of these two members 3, 4; 6 and comes into contact with the other.

Here the slewing ring 1 contains four contact elements (contact rings) 7a, 7b, 7c, 7d:
two 7a, 7b are arranged between the retainer 6 and the outer ring 4, prevent any direct contact between these two members 4, 6, and are fixed to the outer ring 4 and come into contact with retainer 6; and
two 7c, 7d are arranged between retainer 6 and inner ring 3, prevent any direct contact between these two members 3, 6, and are fixed to the inner ring 3 and come into contact with retainer 6.

As can be seen, the contact elements 7a, 7b attached to the outer ring 4 are arranged in axial direction on either sides of the raceway 5, as well as the contact elements 7c, 7d which are attached to inner ring 3.

This substantially symmetrical arrangement of the four contact elements 7a, 7b, 7c, 7d in relation to raceway 5 provides perfect equilibrium of slewing ring 1 with absolutely no point of contact between retainer 6 and either one of the two rings 3, 4. This particular configuration is of particular interest for slewing ring 1 whose rolling elements 2 describe a circle of large diameter (for example at least 1 m, even 1.5 m or over), and especially for rings used to orient devices subjected to strong pressures such as the slewing ring 1 used to direct blades in relation to the rotor of a wind turbine nacelle according to wind force.

In the present example, the contact elements 7a, 7b, 7c, 7d are circular rings force fitted into corresponding grooves 8 made in concentric rings 3, 4. As can be seen in the FIGURE, the straight section of these circular rings may be trapezoidal, rectangular or semi-circular. The circular rings are made of a compact material, i.e. non-porous. Preferably they are made of a single piece.

In conventional manner the slewing ring 1 also includes seals to retain the lubricant within the housing defined by the two rings 3, 4 and in which the ball elements 2 and retainer 6 are confined.

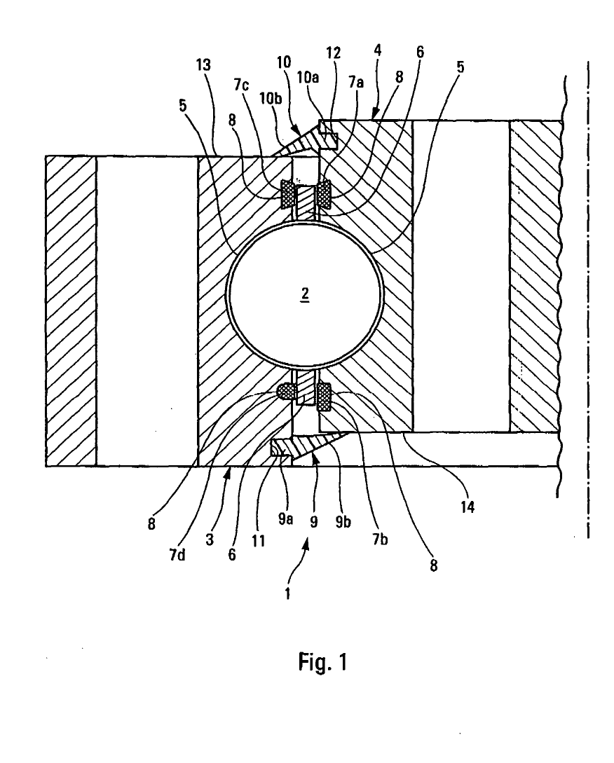

Slewing ring 1 may therefore include in particular lipped seals denoted 9, 10 in FIG. 1, each comprising a base 9a, 10a, inserted in a corresponding notch 11, 12 of respective ring 3, 4, and a lip 9b, 10b bearing upon a corresponding transverse surface 14, 13 of the other ring 4, 3.

Evidently, the present invention is not limited to the above-described embodiment.

It would be possible for example to have contact elements solely between the inner ring and the retainer or between the outer ring and the retainer, although this would give the present invention much lesser efficacy.

It would also be possible not to have any contact element (contact ring) on either side of the raceway (in axial direction).

It would also be possible for the contact elements to be fixed to the retainer.

It would also be possible for the contact elements to be made of any polymer material other than polyamide, for example of polytetrafluoroethylene or polyimide. These contact elements could also be made of non-ferrous metal, for example a copper or bronze alloy.

It would also be possible to use other fixation means for the contact elements depending upon the constituent materials: they could be fixed chemically (bonded for example), metallurgically (welded or brazed for example) or mechanically (clipped or bolted for example).

It would also be possible to use rolling elements other than ball elements, for example rollers.

1-10. (canceled)

11. A slewing ring comprising rolling elements, two concentric metal rings having a predetermined hardness, one inner and one outer, mobile in rotation relative to one another and defining a raceway for said rolling elements, and a retainer made of a metal having a hardness substantially equal to the predetermined hardness of the rings, the retainer being arranged between the two rings, and being integral in rotation with the rolling elements, said retainer holding the rolling elements regularly spaced apart in the raceway, at least one circular contact ring made of a material having a hardness different from the predetermined hardness of the rings and the hardness of the retainer, each said circular contact ring being housed in a groove made in one of the two rings, and the retainer coming into contact against each said circular contact ring, thereby preventing any direct contact between the retainer and the ring in which the groove is made.

12. The slewing ring as in claim 11, wherein the rings and retainer are made of steel and wherein each of the contact rings is made of a non-ferrous material.

13. The slewing ring as in claim 11, wherein each of the inner ring and outer ring has at least one groove in which a contact ring is housed.

14. The slewing ring as in claim 11, wherein at least one groove in which a contact ring is housed is formed on either side of the raceway.

15. The slewing ring as in claim 11, wherein each said contact ring has one of a trapezoidal straight section, a rectangular straight section and a semi-circular straight section.

16. The slewing ring as in claim 11, wherein each said contact ring is made of a compact, non-porous material.

17. The slewing ring as in claim 11, wherein each said contact ring is made of a non-ferrous metal.

18. The slewing ring as in claim 11, wherein each said contact ring is made from a polymer material.

19. The slewing ring as in claim 11, wherein each said contact ring is fixed to a corresponding ring through one of a mechanical fixation, a metallurgical fixation, and a chemical fixation.

20. The slewing ring as in claim 11, wherein the rolling elements comprise ball elements.
